(19) United States
(12) Patent Application Publication
(10) Pub. No.: US 2008/0035722 A1
(43) Pub. Date: Feb. 14, 2008

(54) Label system and method for returning lost articles

(76) Inventor: Mark Feld, Baltimore, MD (US)

Correspondence Address: BARBER LEGAL, P.O. BOX 16220, GOLDEN, CO, 80402-6004, US

(21) Appl. No.: 11/502,327

(22) Filed: Aug. 10, 2006

(51) Int. Cl. G06F 17/00; G06Q 30/00

(52) U.S. Cl. 235/375; 235/385

(57) ABSTRACT

The present invention teaches a method and device for return of lost articles, comprising a label affixed on the article/item, an instant registration of the user, and a central registry identified upon the label having contact information associated with the user. Lost and found locations will be made aware of the device and system of the present invention and will offer it to consumers upon purchase of a product, rental of an item or service, hotel/rental counter check-in or rental counter. The labels of the invention contain a centralized database telephone number or web address, and an anonymous owner number. The centralized database and return center then communicates with the owner informing them of their found item.

### CROSS REFERENCE TO RELATED APPLICATION

This application and device claim the benefit and priority of provisional application No. 60/433,403 filed in the United States Patent and Trademark Office on Dec. 14, 2002 and entitled LABEL SYSTEM AND METHOD FOR RETURNING LOST ARTICLES in the name of the same inventor, Dr. Mark Jay Feld, and also of U.S. application Ser. No. 10/737,667, dated Dec. 15, 2003 and entitled LABEL SYSTEM AND METHOD FOR RETURNING LOST ARTICLES in the name of the same inventor, Dr. Mark Jay Feld.

### FIELD OF THE INVENTION

This invention relates generally to human-readable identification devices and specifically to adhesive labels having identification material thereon, and to methods of increasing the rate of return of lost articles and articles turned into institutional lost and found departments using human-readable devices.

### STATEMENT REGARDING FEDERALLY FUNDED RESEARCH

This invention was not made under contract with any agency or branch of the United States Government.

### BACKGROUND OF THE INVENTION

Most public locations have institutional lost and found offices. The purpose of these locations is to store lost items. Examples of public locations that have lost and founds include restaurants, hotels, car rental locations, bus stations and airports. These locations usually function as follows: when an item is found it is usually given to a person designated to deal with lost and found items. The lost item is cataloged and stored. There the item waits until someone, often the actual owner, comes to claim it.

This process is frequently not successful or efficient. This is so because it is primarily dependent on the owner. Lost and founds in most cases do not have any actual ability to return found items. The primary reason for this is because, in the great majority of cases, the owner of the item cannot be identified. It is true that in a small percentage of cases the item has been labeled with the owner's identity and contact information: in such cases, the finder or lost and found department is almost always happy to call and notify the owner of the location of the found item. Diligent lost and found managers make an effort to return certain items such as cell phones and electronic organizers. They do so by trying to identify contact information such as a “home number” found in the address book, by calling themselves with a lost cell phone and trying to identify the name/number of the telephone owner using caller ID, and by similar makeshifts. These take up significant time and are usually not successful, with the natural result that even making such efforts again for the next items becomes less economical.

A statistical example is useful to understand the magnitude of the problem. In New York's Grand Central Station, a modest 60% return rate is achieved, and even that modest rate of success is reached only by undertaking the burden of dialing numbers found in the directories of telephones in the inventory. The effort devoted to this activity for 3,000 cell phones per year is easy to imagine. This contrasts with a 1% return rate reported by a major US airline(Southwest). This airlines effort also requires 4 full time employees. Clearly, it is in the benefit of Grand Central Station and all other large institutional lost and founds to have some method available to them for aiding the return of items on a systematic basis.

Restated, a system is needed which is geared towards the needs of the lost and found institutions. In particular, a system is needed which actually allows lost and found institutions to return lost property by offering a method of getting it back to its owners. However, as will be discussed later, most known return systems are geared strictly towards a consumer who is expected to proactively carry out several step processes to join the system.

There are even countervailing tendencies: most law enforcement officials suggest that labeling items with personal identifying information is not safe and therefore is not recommended. Even when the owner does manage to claim the lost item there has been a significant expenditure of time and energy. The owner usually does not know where the item was lost so there is an effort to backtrack to all the previous locations to which the owner has previously gone. This could involve multiple locations and these locations need to be contacted by phone or personal visit. This not only takes up the time of the owner but also is burdensome for the lost and found. For every person that calls and is lucky enough to find their item many more people call and their item is not there

Common sense also bears out this understanding of the problem. Almost everyone has the experience of accidentally losing something of value. The loss of personal property, particularly if it has sentimental value, can be very frustrating. The need exists for lost and founds to actively return items to their rightful owners.

Factual data also shows the magnitude of the problem. Every year 3,000 cell phones are turned in to the lost and found in Grand Central Station, meaning that at any one time there are hundreds of cell phones in the office, and as mentioned previously, 40% of them will never be returned. This is about 1,200 telephones a year from this one location, not counting laptops, pagers, cameras both electronic and photographic, PDAs, camcorders, MP3 players, radios, sporting goods and equipment, luggage, briefcases, books, videos, art, optical disks, glasses, umbrellas, accessories of every kind and every other type of portable consumer device imaginable. Multiply the Grand Central statistics by the thousands upon thousands of smaller and larger lost and founds across the nation to obtain some idea of the staggering number of items with this problem: in one year Portland Airport had 16,000 lost items while a single hotel/casino in Las Vegas ended up with 30,000 items and London taxicabs “received” 1,300 PDAs, 2,900 laptop computers and 62,000 cell phones in just 6 months.

The purpose of the label device and method of this invention is to facilitate the return process for locations that have lost and found departments. It is to provide a turnkey system designed for locations that operate lost and founds. The system is designed to increase the rate of return of lost articles submitted to lost and found departments Another purpose of this method is to increase the loyalty people feel for organizations with which they deal.

The need for this device is twofold. First, as described above the traditional lost and found mainly functions as a repository of lost items. Items are not returned to owners unless the owner pursues the lost item. This method will allow for the lost and found to return the item without waiting for the owner to initiate the return process. Second, with the advent of new technology the number of portable items people carry has increased. It is not uncommon to see a business traveler at an airport talking on a telephone while looking at an electronic organizer and a laptop computer. This is a big change from even a few short years ago when keys, wallet and sunglasses were all one had to worry about.

Some factors bearing on the loss of articles can be noted in passing.
1) Many people lose things in a few types of locations, because of the nature of such places (people hurry off of airplanes and out of airports, forget items in hotel room desks and their rental cars, etc).
2) Certain types of locations maintain large institutional lost and found collections. Police departments, security departments, large companies, malls, department stores, retailers, office buildings, airports and airlines, bus lines, train lines, subway systems, car rental agencies, travel agencies, hotels, resorts, restaurants, trade shows, conferences, convention centers, health clubs, college campuses, college dormitories, college buildings, and reservation centers for commercial services like the above. All of these locations want for reasons of liability to responsibly divest themselves of lost and turned in items, and most such locations make some form of sporadic effort to locate owners.
3) Even in the case of theft, it is quite common for an item's case to be rifled for any wallet or purse therein, then the quite valuable item in the case (a laptop or telephone, etc) is itself simply dropped in the nearest trash receptacle and ends up at a local police department, sans identification information.
4) There is some threshold at which the effort to locate the owner of a found object simply exceeds the patience and liability level of the finder. Below that level, the effort to return the object will be made, above that level, the object sits and gathers dust until it is auctioned off, sold in bulk, thrown away or otherwise disposed of. This threshold exists but is not terribly high.
5) Economics dictates that there be some financial reward for the distribution of identification labels, and a financial reward for maintenance of a database of owner contact information. But most systems to date are geared around a proactive consumer.
6) Finally, it goes without saying that the number and value of items that travelers use hastily and then potentially forget (cellular telephones, PDAs, portable computers, entertainment devices, games, CD players, MP3 players, electronic devices, etc) is increasing quickly. Add the fact that airlines carry over 600 million passengers in the US alone during a peak year and the result is a mobile population having numerous small expensive devices to lose.

References disclose that a certain amount of imagination has gone into attempting to solve these issues.

Various services are available to consumers, normally based upon the Internet and/or a requirement that the consumer purchase labels. Examples of these systems include those found at www.stuffbak.com and www.boomerangit.com. Both sell labels to consumers by requiring the consumer to order it from the website or an office supply store. In addition, both systems rely upon a unique identifier number for each and every label. This is overly complex, as the typical consumer is required to register labeled items one at a time, including a registration process requiring entering the long label numbers individually. Worse, both rely upon delayed or multistep registration processes such as: place an order on the Internet, await snail mail delivery, then affix labels. In one case (www.boomerangit.com) it appears that the service may be paired “in box” with the products of a given manufacturer. Obviously, this does not work with every possible product of the consumer's choice and there is no provision for institutional lost and founds to speed widespread acceptance of the service. Also this system does not work with the distributor/retailer and no instant registration is possible, dramatically increasing the likelihood that the consumer will never register. In the case of the system, (www.stuffback.com) the finders of lost items, are expected to use a website to locate a “drop off” center close to them, then transport the lost item to that center. This is a step which increases the burden on the lost and found institution or individual rather than decreasing it.

The market penetration of these services is extremely low due to the fact that they do not work with lost and found locations rather the individual who may lose something. and they do not easily push items into a registered status.

Patent Publication No. US 2002/0072924 A1 published Jun. 13, 2002 in the names of Gray and Leslie teaches a computer implemented system in which the finder of an item is expected to search a computer database for the item to determine if it has been registered with the service. The database may be accessible over the Internet. It is difficult to believe that large numbers of lost and found departments (or individual finders) will voluntarily put themselves through a computer search process for the benefit of an unknown stranger. Owners are also unlikely to take the time to input enough “classification” and “subclassification” tags (to borrow PTO parlance) to make identification of a specific item easy during the search.

Patent Publication No. US 2002/0014955 A1 published Feb. 7, 2002 in the name of Klitsgaard teaches a wireless identification tag using a wireless protocol such as “Bluetooth” (Registered Trademark of Microsoft Corporation) to physically locate the lost object. However, given the short range of items designed for the Bluetooth protocol (a few feet/meters) this is not a practical method except in those circumstances in which the area of loss is known and fairly small. In addition, the cost and manufacturing issues involved with a wireless luggage tag may render the system less economically practical. In addition, this does not seem to directly relate to adhesive tags.

U.S. Pat. No. 5,878,116 issued Mar. 2, 1999 to Scott for METHOD OF LOCATING A LOST PET, PERSON OR OBJECT teaches that an identification label for pets may be provided with a unique telephone number having a voice mail box: finders may easily call the number and leave a message which the owner may then listen to from the voice mail box. While this makes the finder/lost and found department manager much more likely to undertake return of the article (a single easy telephone call), the cost of maintaining a large system of voice mail boxes is likely to have an impact on the economic viability of the system when applied to items of less value than pets and family members.

U.S. Pat. No. 5,809,481 issued Sep. 15, 1998 to Baron et al for ADVERTISING METHOD AND SYSTEM teaches a business method: identification tags may advantageously be used as a ‘bribe’ to induce consumers to apply labels advertising the services or products of a sponsor. This system harnesses advertising money to cover overhead of maintaining a contact information database, but the potential problem with this system is that most consumers do not desire to clutter up valuable possessions with advertising matter. An additional fact to note about this system is that the patent states (col. 7, lines 22 through 35) that the consumer is “instructed” to fill out a registration card and return it (presumably by post) to a central processing facility. Many consumers will be unmotivated to do this delayed registration, rendering both advertising and labeling functionality moot.

U.S. Pat. No. 5,576,716 issued Nov. 19, 1996 to Sadler for OWNER ORIENTED SYSTEM FOR LOCATING LOST OR STOLEN PROPERTY teaches the use of a GPS (Global Positioning System) Module, computers, modems, and of course the satellite system in geosynchronous orbit which makes the GPS system work in order to maintain a continuous “novel location” track on an object. This reference may not be technically relevant to the instant invention's electronic, physical or printed labels and seems to be structurally dissimilar.

U.S. Pat. No. 5,180,192 issued Jan. 19, 1993 to Herbert for LOST PERSONAL ACCESSORY ITEM IDENTIFICATION AND RETURN METHOD AND ARTICLES teaches the use of a bar-code and thus bar-code scanner on an item label, along with the phrase “RETURN POSTAGE GUARANTEED” or a similar phrase acceptable to the US Postal Service to provide delivery. While the system addresses security issues by not providing owner information to casual finders, and is does not require a large amount effort on the part of finders, it may be unnecessarily complex, and involves unnecessary handling of found articles (shipping from the location of finding to the central facility, then return to the location of the owner, even though finding location and the owner will often be proximate.)

The same issues apply to U.S. Pat. No. 4,271,352 issued to Thomas on Jun. 2, 1981 for LOST PERSONAL ACCESSORY RETURN METHOD AND ARTICLE: dual mailings and unnecessary handling.

Finally U.S. Pat. No. 3,094,799 issued Jun. 25, 1963 to Hines for IDENTIFICATION TAG is perhaps the most practical compromise seen in the prior art. Opening the device reveals a mailing label, with postage pre-affixed. The finder need only drop it into a mailbox and the USPS handles the rest. Note that that system does compromise security of the owner, since the mailing address is provided. In addition, this final items suffers from a problem common to any item which has contact information for the owner directly on the item itself. The problem with this is that when the owner's contact information changes, every tag on every item becomes out of date and must be changed individually.

It would be advantageous to provide a system to lost and found institutions which would enable them to return lost property to owners easily and cheaply.

It would further be advantageous to provide a system which provides incentives to retailers and consumers to actually get devices registered at the point of sale in a matter of moments.

It would further be advantageous to have a system by which owners could update one item of information for all items tagged.

It would further be advantageous to have a system by which a single user could protect any number of items without individual registration of each item.

It would further be advantageous to provide a system which is easily administered and inexpensive to implement.

It would further be advantageous to provide a system geared to the needs of businesses and organizations overwhelmed by lost items, and to offer it in a manner designed to increase customer loyalty.

### SUMMARY OF THE INVENTION

General Summary

The present invention teaches a device for return of lost articles, comprising an electronic, physical or informational tag or label affixed on the article/item, a device enabling instant registration of the user at the point of sale regardless of the type of good bought, and a central registry identified upon the label having contact information associated with the user. A method aspect of the invention teaches the steps of carrying out the invention.

The invention may be embodied as a traditional consumer oriented service focused on the customer level of service. However, the invention specifically allows an easing of the burden on organizations which are forced by circumstances to make lost and found services available to the public. Examples of this type of organization include transportation services ranging from rail-lines to subway lines to bus lines, airlines and airports, as well as public venues such as stadiums and convention centers. In addition hotels, rental car companies, college campuses and similar locations must maintain large lost and founds. The same is true of large commercial buildings with many commercial or residential renters. Malls, the retail stores within malls, and restaurants deal with this problem on a daily basis. For such organizations, it would be convenient to have a turn key system allowing easing the lost and found burden. The present invention extends the functionality of the lost and found process and garners customer gratitude whenever an item is returned, and accomplishes these goals without increasing lost-and found work-load. On the contrary, for the typical lost and found the present invention is specifically designed to ease the workload and decrease the number of items held. Most importantly, as an extension of existing lost and founds, the registry specifically provides for the distribution of the system by participating lost and founds.

Customers will be made aware of the device and system of the present invention upon purchase of a product, rental or reservation of an item or service, check-in at a hotel or rental counter, or through information in their room/purchase/rental car etc. Lost and found organizations interested in promoting the service might use such places as mall and airport information desks to provide the labels of the service. Lost and founds not otherwise participating may still be provided with information allowing them to easily recognize devices having the invention thereon and the ease of use of the invention explained.

On the other hand, as this is also a device and method to increase customer loyalty as well as improve the return process, customers may be given the option to use the device and enroll in the system for free when used by a retailer. After the customer is informed about the service a key element is that the customer can enroll and activate membership at that time: instantly. This instant registration is crucial for those customers who want to be protected immediately: travelers, business people, students, and others who will not receive utility from a slow registration device. It is also crucial to the method of the system, as later registration is likely to be a step many customers would bypass, thus rendering the system ineffective.

Membership information is not kept by the location providing the label (the airport, the airline, the mall, the mall based retailer) but rather is forwarded to a centralized database. This information is not shared with anyone, including the person finding a lost item, unless the member's permission is given. After a very short application having a request for contact information is filled out and returned, a customer is given a selection of labels to attach to their personal property. In alternative embodiments, the user may call the registry directly without a form, or may use a website, the computer system of the participating organization, etc. These labels contain a telephone number, preferably toll free, (or web address) to be contacted to return a lost item. These labels also contain an owner number that is attached to a record in a central database. The number can also include or identify the particular lost and found location that enrolled the customer. This information can be used in multiple ways but can be used to calculate the amount of revenue a particular location should be paid for signing up customers, because in embodiments, retailers and service providers may receive inducements to sign up customers. If an item is subsequently lost and found by an individual motivated to assist the owner, or is submitted to an institutional lost and found, the individual seeing the label calls a toll free number to report the item. That person is asked to read the “owner number from the label”. No identification of the item by model number or type is necessary: the owner number is sufficient information.

The centralized database and return center then communicates with the owner informing them of their found item. The owner can choose to pick it up or the item can be sent to owner through the mail or private delivery service. A key aspect of the program is that the return process will work from any lost and found. It is not limited to the location at which the individual signed up. In some cases such as an airline or a hotel the individual may use the same company or location on regular basis. An example of this would be a business traveler who frequently flies on a first airline and stays at a second hotel. Such a traveler might be more likely to lose their item in the same location as that at which they acquired the label and subscribed to the service, but the return process could actually be initiated from any location.

It is important to remember that the location does not have the burden of contacting the owner nor of setting up the return process. In the preferred embodiment, the finding location merely calls a toll free telephone number, which actually represents a diminution of the responsibilities of such lost and found organizations. In other embodiments, an email or website connection may be used. Contacting the owner and handling the return are the responsibility of the company maintaining the centralized database. This increases the effectiveness of the lost and found but does not increase the workload for the location offering the service.

Principles Relating to the Present Invention

In order to achieve the objectives stated above it is suggested that an electronic or physical or adhesive label bearing an owner code and contact information for a return office for contact by a finder of a lost labeled article be provided. The owner simply adheres a label to each article. The finder of a lost article reads the contact information, contacts the return office and provides the code. The code identifies the owner. The return office arranges for return of the lost labeled article to the owner. If the finder is an employee of an organization which maintains a lost and found department (generally called “points of service” in this application) the return office operates as an extension of the existing system. The finder simply returns the lost labeled article to the existing lost and found department, in accordance with existing procedure, and the lost and found department uses the owner code to identify the owner by communicating with the central database and arrange for return of the lost labeled article using the owner information correlated with the owner code.

If the finder is a member of the public and return of the article to a lost and found department is inconvenient the contact information for the return office is utilized and the owner code used by the return office to identify the owner. In any case the identity of the owner is protected by the owner code and it is not necessary for the label to bear information enabling a finder to identify the owner without the owner's permission. A reward can be made available and this information further provided on the adhesive label as possible inducement for a member of the public to contact the return office and return the lost labeled article, either to the return office or, if the owner gives permission to reveal a return address to the finder, to the owner directly. It is necessary, in any case, for the return office to possess a registry correlating the owner code with owner identification and return information including at least contact information, e.g. telephone number or -mail address, or return address so the owner can be either contacted to arrange return and/or return simply made to the address given. The owner must provide this return information to the return office and the return office must correlate this return information with the owner code. It is suggested that this be done at the time the adhesive labels are provided to the owner. It is only necessary for the owner to provide this return information once with any given return office. The registry, moreover, can be correlated with customer information already on record resulting form initial registration, for the purpose of providing the return office with return information, or any other purpose including but not restricted to making a hotel, airline, or rental reservation. In many cases the owner can simply be offered the adhesive, electronic or physical labels at the time of checking in, after the reservation has been made, and when a room. scat, or vehicle. for example, is assigned. The owner of the articles to be labeled must be present at a reservation desk to obtain a hotel key, boarding pass, or vehicle key, for example, and is readily offered the labels in person at that time. The information desk at a shopping mall is another example in which reservations have not been taken but at which personal provision of the labels to the owner can be made.

Summary in Reference to Claims

It is therefore one aspect, advantage, objective and embodiment of the present invention to provide a device for providing easy return to a user of an item if lost, the device comprising: a) a tag applied to such item; b) the tag having thereon convenient contact information of a central registry; c) the tag having thereon a user identification; d) the tag provided to such user by a participating organization; wherein e) a communication device capable of providing the user identification to the central registry along with contact information for such user, at the time when such user is provided with the tag by the participating organization.

It is therefore another aspect, advantage, objective and embodiment of the present invention to provide a device wherein the tag further comprises: f) an adhesive label bearing thereon the convenient contact information of the central registry and the user identification in human readable form.

It is therefore another aspect, advantage, objective and embodiment of the present invention to provide a device wherein the human readable form further comprises of one member selected from the group consisting of: Braille, lettering, indicia of the central registry, indicia of the user identification.

It is therefore another aspect, advantage, objective and embodiment of the present invention to provide a device wherein the communication device capable of providing the user identification and the user contact information at the time the user is provided with the tag further comprises: a telephone and telephone number provided to the participating organization.

It is therefore another aspect, advantage, objective and embodiment of the present invention to provide a device wherein the communication device capable of providing the user identification and the user contact information at the time the user is provided with the tag further comprises: a computer network and protocols provided to the participating organization.

It is therefore another aspect, advantage, objective and embodiment of the present invention to provide a device wherein the computer network and protocols further comprise one member selected from the group consisting of: the Internet, the participating organization's own computer network, a dedicated network, and combinations thereof.

It is therefore another aspect, advantage, objective and embodiment of the present invention to provide a method of facilitating the return of a purchased and lost article comprising: a) offering to a user at the point of purchase of the article a tag to apply to the article, the tag having thereon a user identification and further having thereon convenient contact information of a central registry; b) instantly registering with a central registry the user identification and contact information of the user; c) when the finder of the article uses the convenient contact information to contact the central registry, contacting the user from the central registry to inform the buyer of the finding of the article.

It is therefore another aspect, advantage, objective and embodiment of the present invention to provide a method wherein the step b) of instantly registering with a central registry the user identification and contact information of the user further comprises: b1) dialing on a telephone a pre-provided telephone number to the central registry; and b2) providing to the central registry the user identification and contact information of the user.

It is therefore another aspect, advantage, objective and embodiment of the present invention to provide a method wherein the step b2) of providing to the central registry the user identification and contact information of the user further comprises one member selected from the group consisting of: pushing buttons on the telephone to generate DTMF codes, speaking to a central registry worker, and combinations thereof.

It is therefore another aspect, advantage, objective and embodiment of the present invention to provide a method wherein the step b) of instantly registering with a central registry the user identification and contact information of the user further comprises: b3) accessing on a computer terminal a software device provided by the central registry; and b4) inputting on the computer terminal the user identification and contact information of the user.

It is therefore another aspect, advantage, objective and embodiment of the present invention to provide a device for providing easy return to a user of an item if lost, the device consisting of: a) a tag applied to such item; b) said tag having thereon convenient contact information of a central registry; c) said tag having thereon a user identification; d) said tag provided to such user by a participating organization; wherein e) said user identification is provided to said central registry along with contact information for such user, at the time when such user is provided with said tag by said participating organization.

It is therefore another aspect, advantage, objective and embodiment of the present invention to provide a method of facilitating the return of a lost article comprising: a) offering to a point of service a plurality of tags, each of the tags having thereon a user identification and further having thereon convenient contact information of a central registry; b) urging the point of service to offer to a user at least one tag to apply to at least one article; c) instantly registering with a central registry the user identification and contact information of the user; d) when a finder of the article uses the convenient contact information to contact the central registry, contacting the user from the central registry to inform the buyer of the finding of the article.

It is therefore another aspect, advantage, objective and embodiment of the present invention to provide a method wherein the point of service comprises one member selected from the group consisting of: rental agencies, hotels, airlines, airports, bus stations, restaurants, institutional lost and found collections, police departments, security departments, large companies, malls, office buildings, bus lines, train lines, subway systems, travel agencies, resorts, trade shows, conferences, convention centers, health clubs, college campuses, college dormitories, college buildings, reservation centers, and combinations thereof.

It is therefore another aspect, advantage, objective and embodiment of the present invention to provide a method wherein the point of service comprises retailers.

### BRIEF DESCRIPTION OF THE DRAWINGS

FIG. 1 is a diagram of the label of the invention shown as a single record according to a first device embodiment of the present invention.

FIG. 2 is a diagram of a single record at the central registry of the invention according to a second embodiment of the present invention.

FIG. 3 is a block diagram showing information and label flow between entities involved in the use of the present invention in embodiments.

FIG. 4 is a flow chart showing the use of a third (method) embodiment of the present invention.

FIG. 5 is a front elevational view of a physical tab embodiment of the present invention.

FIG. 6 is a front elevational view of an electronic and bar code embodiment of the present invention.

FIG. 7 is a block diagram of an overall network for the present system.

### INDEX TO REFERENCE NUMERALS

10 Label
12 Organization Information
14 Central Registry Contact Information
16 User Identification
20 Record
22 User Identification Field
24 User Contact Information Field
26 Finder Contact Information Field
30 Participating Organization
32, 34, 36, 42, 44, 52, 66 Steps
40 Central Registry
50 User
60 Finder
102 Provide Instant Registration to User
104 Provide Label to User and Affix to Article
106 Loss of Article with Affixed Label
108 Central Registry Contacted by Finder
110 Finder Provides User Identification
112 User Contact by Central Registry for Return of Article
200 Tag
202 Indicia
204 Tab
206 Slot
208 Different Slot
300 Tag
302 UPC Barcode
304 Machine Readable Interface
402 Central Registry
404 Internet
406 Communications Network
408 Computer
410 Telephone
412 Machine Reader

### DETAILED DESCRIPTION

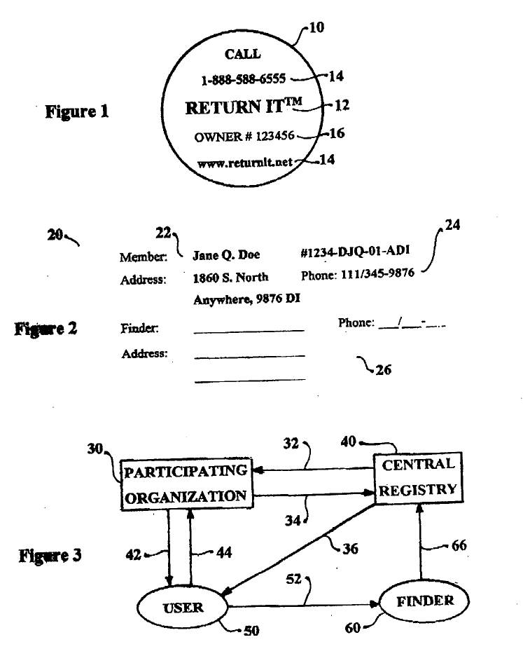

FIG. 1 is a diagram of the tag/label of the invention shown as a single record according to a first device embodiment of the present invention. Label 10 contains three fields of information: organization information 12, central registry contact information 14 and user identification 16. While for reasons of cost and ease of use, an adhesive label embodiment is the presently preferred embodiment and best mode now contemplated for carrying out the invention, there are numerous other embodiments of the invention. The device of the invention may be embodied has a tag or label which is human readable, electronically or physically machine readable, or a physical item which conveys the desired information, etc. Physical items may use tabs or notches for identity and may rely upon the central registry trademark or other indicia of the central registry for the convenient registry contact information. Braille lettering, lettering upon the device/tag/label or other human readable formats may be used, as well as other types of indicia of user identification.

Label 10 is pictured as a round adhesive label, but also may be a typical computer data record having three fields, which is in fact an alternative embodiment of the invention. Label 10 may in other alternative embodiments be rectangular, elongated or any other shape. It may be non-adhesive or even non-paper or silicon based without departing from the scope of the invention. It may be waterproofed, plastic or plastic coated, otherwise treated for durability, washability, weather-resistance, or other desirable properties.

It will be seen in FIG. 5 that the device 200 of the invention may rely upon a trademark or other indicia of the central registry (the markings 202 on the device are not any real trademark known to applicant) and may rely upon physical features such as tab 204, slot 206 or different slot 208, in order to convey user identification. A sequence of colors might also be used.

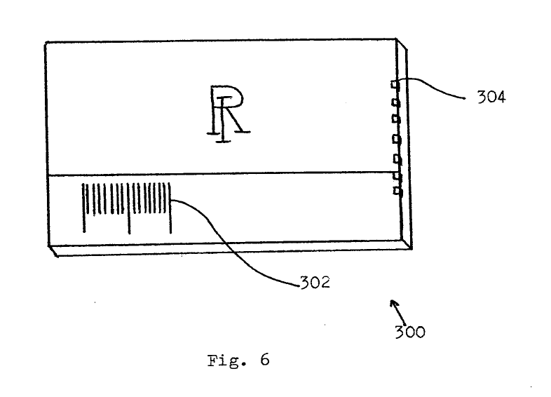

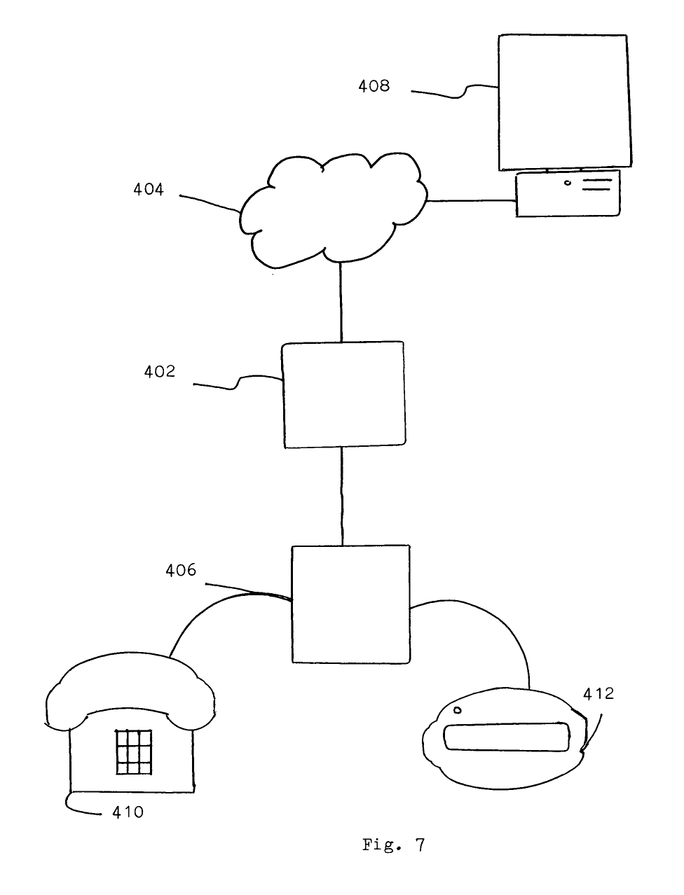

It will be seen in FIG. 6 that the device of the invention may be a machine readable form 300 such as a bar code, UPC bar code, memory chip, magnetic storage device or optical storage device: use of a common type would be preferable in such embodiments. An electronically readable interface 304 for an internal electronic memory, and a barcode 302, are both shown as examples of such embodiments.

Central registry contact information 14 may advantageously comprise a toll free telephone number in the preferred embodiment, as such toll free numbers have inherent advantages in terms of convenience of use of the finder (access to telephones is presently more widespread than access to the Internet, telephones are easier and less threatening to use and more). However, in less preferred embodiments, central registry contact information 14 may comprise the address of a website, an email address, a TTY line, a facsimile number, a telegraph number, other computer network specific identification, a universal address of the “http:” format, and combinations thereof.

User identification 16 will in all presently preferred embodiments and best modes now contemplated for carrying out the invention comprise a number or alphanumeric sequence, and only in less favored embodiments will this constitute an actual identifier of the individual by name, address, contact information etc. This is for privacy and security reasons.

Organization information 12 may comprise advertising material, a word mark or logo, a store identifier, an organization identifier such as a university mascot, or combinations thereof. In embodiments, organization information 12 may be omitted or combined with user identification 16 or central registry contact information 14. For example, in an alternative embodiment, organization information 12 might comprise a number “xxxxx” identifying a particular organization, while user identification 16 might comprise a number “yyyyyyyy” identifying a particular user of the invention registered with the central registry. These might be combined in the format “xxxxx-yyyyyyy” in a single field identifying (in the central registry database) both the participating organization at which the labels were obtained and also the user. In another alternative embodiment, organization information 12 might comprise identifiers to a website or toll free number and thus be combined with central registry contact information 14. For a first example of such another alternative embodiment, the central registry information 14 might be a toll free number which itself is specific to the participating organization, or in a second example of such another alternative embodiment, the toll free number could be common to more than one participating organization but an extension number may be appended which is specific to the organization. A third example might be a website specific to a single participating organization (for example, “www.return-this-willard-hall-university-colorado.com”), and a fourth example might be a website having sub-pages (for example “www.return-this.com/floyds-fauvists-art-gallery”). Finally, as state previously, organization information 12 may be omitted entirely, as this information may be inherent in the central registry discussed next.

The point of service or participating organization terms refer to the organization which provides some service desired by the user, such as a car rental agency, hotel or the like. These terms may also refer to organizations which perforce maintain lost and founds. Participating organizations or points of service may comprises one member selected from the group consisting of: rental agencies, hotels, airlines, airports, bus stations, restaurants, institutional lost and found collections, police departments, security departments, large companies, malls, office buildings, bus lines, train lines, subway systems, travel agencies, resorts, trade shows, conferences, convention centers, health clubs, college campuses, college dormitories, college buildings, reservation centers, and combinations thereof, as well as related and similar organization.

Note that retailers may also be participating organizations or points of service in certain distinctly different embodiments. The point of sale of the invention is one possible alternative time to approach the consumer. However, it is felt that the organizations which have lost and found problems (airports, police departments, universities and so on as listed above) and normally have a registration or rental procedure, may be most easy to urge to supply users with the device of the invention. The procedures of the invention are also designed to aid such locations as lost and found departments, bus lines, airlines, car rental agencies, hotels, convention centers and the like.

Note that as the typical situation is one in which the user of the device/method is well aware of the nature of the lost article, it is not necessary to identify the article, either by its own nature or on the label. A user, notified that a lost item has been found, will not normally have any problem knowing what item was lost.

FIG. 2 is a diagram of a single record at the central registry of the invention according to a second embodiment of the present invention. While this is pictured as a single paper record embodiments may be on multiple paper items (for example as a card file or registry document) or in other forms, specifically including an electronic database, having a plurality of similar fields. In general, the central registry of the invention will have a plurality of such records. The central registry may itself be accessed by means of the central registry contact information 14. In the preferred embodiment, central registry contact information 14 is a toll free telephone number and dialing it actually causes connection to a human operator. In less favored embodiments, the telephone may be answered by a computer, an answering machine, a voice mail system (which may be keyed to user identification 16 or organization information 12), or combinations thereof. In other embodiments, the central registry may be a website offering “one way” contact from finder to user without any contact information being provided to the finder (for reasons of security and privacy), a central office, or combinations thereof.

Record 20 contains a user identification field 22, user contact information field 24, and finder contact information field 26, the last item normally being blank.

In embodiments in which the central registry is a website, or the contact information sent by the finder is an email, the finder will NOT have to engage in any form of search or database search or web search for the item or user. Simply by informing the central registry of the user identification number 16 and the contact information of the finder, the finder has carried out their entire responsibility. The central registry will access record 20 by means of user identification 22 and will then use the user contact information 24 to send a message to the user that an item of the user's has been found.

User and finder contact information present in the central registry may consist of any or all of the following, including combinations or expansions thereof: domicile address, organization address, temporary address, driving/walking instructions, email addresses (organization, personal, relatives), telephone numbers (temporary, permanent, hotel, organization, personal, mobile, facsimile, relatives, contact individuals, co-workers, colleagues, toll free) and other fairly normal identifiers. Note that it is distinctly advantageous for the user if there are numerous user contact information fields present in the central registry rather than just one, thus allowing use of numerous methods of contacting the user. This is true because an individual may move, change contact information, change employment, be on business travel, or be at a situation or location in which they may be contacted by certain individuals but not by others. Thus, at the time of instant registration of the user, it is desirable to seek a large number of contact fields of various different types.

Provision of finder contact information may be on an ad hoc basis, as needed, or it may be systematized in advance. Finder contact information may be associated with record 20 as shown in the preferred embodiment, or it may be kept separately in alternative embodiments.

Provision of such user identification and user contact information, however, is instant in the preferred embodiment. At the time the user is provided with label 10, they will be requested to provide user contact information 24 to the participating organization or directly to the central registry. The advantages of this are obvious in the context of travelers (who may receive the label 10 at a participating organization hotel, airline, travel agency, car rental, etc) who may have immediate need for the device and method of the present invention. An example of this would be a user who registered the invention at the time of buying airplane tickets, then left an registered device behind on the airplane. A delayed registration would be distinctly disadvantageous in such an event. Further advantages include a higher ratio of successful registration of users offered the device/method by participating organizations, “instant gratification” of the desire to have the service/device of the present invention protecting an item newly purchased at a vendor (such as an electronic store, a computer store, an audio store, a department store, a discount outlet, a telephone store/service, etc). Instant registration also allows use of the system at functions otherwise unrelated to loss of personal possessions. For example, college students might be asked provide contact information and take a sheet of labels during the course registration process.

In the preferred embodiment, a clerk at the site of provision of a product or service may explain that the vendor provides the labels and a limited time subscription to the customer/user free of charge. If the user decides to use the device/service/method of the invention, then they are provided with labels having a unique user identification on them. The customer may then provide contact information which is sent instantly to the central registry and protection of any items to which the user chooses to affix the label. The registration process may occur different ways in different embodiments: the user may fill out a card or answer questions posed by the clerk, a sales terminal, or a central registry clerk contacted by telephone. The connection from participating organization to central registry may occur via dedicated computer network, Internet, intranet, telephone, toll free telephone number, email, facsimile or other instant method.

FIG. 3 is a block diagram showing information and label flow between entities involved in the use of the present invention in embodiments. Central registry 40 issues (step 32) label 10 to participating organization 30. In other embodiments, label 10 may be generated by participating organization 30. At step 42, participating organization issues label 10 to user 50, who immediately affixes it to any or all devices which user 50 wishes to protect. User 50 also immediately conveys at step 44 contact information to participating organization 30, who also immediately conveys at step 34 the contact information to central registry 40. In embodiments, this process need not be instantaneous, and in other embodiments, user 50 may contact central registry 40 directly, thus decreasing the amount of personal contact information passing through the hands of participating organization 30.

At the time of loss of a protected device by a registered user 50, the information on label 10 is “conveyed” (step 52) to the finder 60 of the device. Obviously, this conveyance is incidental to the loss of the device.

In the majority of situations, it is likely that finder 60 may represent not just the first finder but eventually a “lost and found” type authority or other authority willing to invest minimal effort in returning the lost item. Thus finder 60 may contact (step 66) central registry 40 by means of central registry contact information 14 (FIG. 1). Central registry 40 may then contact (step 36) user 50 and begin arranging a process of return of the item.

It is another embodiment of the present invention to send to lost and found organizations an information sheet which explains how the labels may be used, the benefits thereof, and stating that the cost to the lost and found may be minimal or nothing. Such information sheets may serve to alert lost and founds of the existence of the new service and to aid them in looking for and recognizing the significance of the tag/label.

This is particularly important in those embodiments in which the central registry relies upon an identifier (such as a trademark) to serve as the contact information, and uses physical devices such as notches or tabs to convey user identity.

Network examples allowing instant registration are further shown in FIG. 7. Central registry 402 may be accessible by means of Internet 404, other computer network 406, or combinations thereof. These in turn may rely upon PC or POS station 408, telephone 410 or machine reader 412.

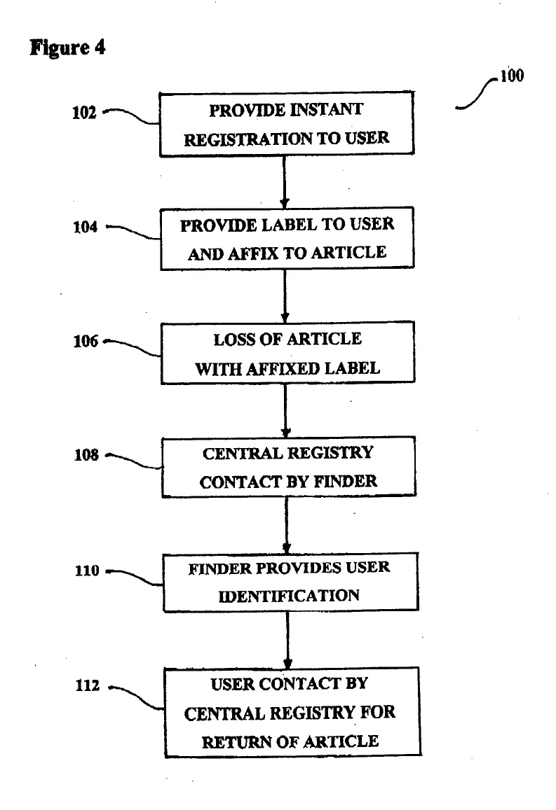

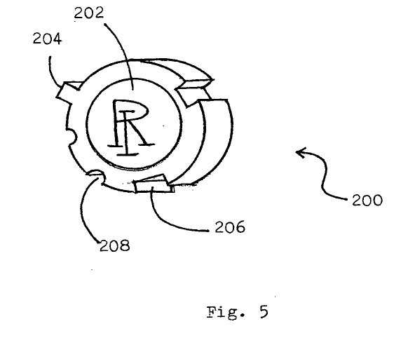

FIG. 4 is a flow chart showing the use of a third (method) embodiment of the present invention. Flow chart 100 shows the steps in the method.
Step 102: Provide instant registration to user 50. This may occur at participating organization 30, or be carried out by central registry 40, or by other methods. In any case, at a minimum, registration steps comprise getting user identification number 22 unique to user 50 associated with user contact information 24 in central registry 40.
Step 104: Provide label 10 to user 50 and affix to item. This step of the method should in the preferred embodiment occur immediately before, after, or during step 102, and any of these options constitutes registration “at the time” of providing label 10.
Step 106: Loss of item. Properly, this is not a “step” of the method but rather an occurrence. However, in testing, demonstration, publicity and other embodiments of the method embodiment, this may be a deliberate step carried out to demonstrate the efficiency or utility of the invention.
Step 108: Contact by finder 60 to central registry 40 using registry contact information 14. As note previously, in the preferred embodiment, this constitutes a toll free telephone call which contacts a human being. In less preferred embodiments, this may be an electronic message, a voice mail, contact to a computer system or site, etc.
Step 110: Finder 60 provides user identification 16 to central registry 40. This provision may by prompted by either label 10 (such as a notice “please type this number on telephone/computer keypad”) or may be prompted by central registry 40 (for example, a human/computer operator prompting the finder 60 by saying “Please tell me the small number at the bottom of the label. The number should be 12 digits long.”).
Step 112: Central registry 40 contacts user 50 and the physical return process is planned. Obviously, central registry will use user contact information 24 for this step, and will hopefully have sufficient such information to contact the user 50 at home, at work, while mobile, when traveling, and to contact family, friends, associates, colleagues and others related to the user 50.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying the corresponding utility application to be filed at a later date.

I claim:

1. A device for providing easy return to a user of an electronic item if lost, the device comprising:
a) a plurality of tags having adhesive thereon, the tags dimensioned and configured to be adhesively applied to such electronic item;
b) the tags having thereon convenient contact information of a first central registry organization;
c) the tags consisting of an anonymous unique user identification code which is the same for each of the tags, the anonymous unique user identification code being unique to the plurality of tags;
d) the tags provided to such user by a second participating organization;
e) a communication device capable of providing the anonymous user identification code to the first central registry organization, associated with contact information for such user, at the time when such user is provided with the tags by the second participating organization.

2. The device of claim 1, wherein the tags further comprises:
f) an adhesive label bearing thereon the convenient contact information of the first central registry organization and the anonymous user identification code in human readable form.

3. The device of claim 2, wherein the human readable form further comprises of one member selected from the group consisting of: Braille, lettering, indicia of the first central registry organization, indicia of the anonymous user identification code.

4. The device of claim 1, wherein the communication device capable of providing the anonymous user identification code and the user contact information at the time the user is provided with the tags further comprises: a telephone and telephone number provided to the second participating organization.

5. The device of claim 1, wherein the communication device capable of providing the anonymous user identification code and the user contact information at the time the user is provided with the tags further comprises: a computer network and protocols provided to the second participating organization.

6. The device of claim 5, wherein the computer network and protocols further comprise one member selected from the group consisting of: the Internet, the second participating organization's own computer network, a dedicated network, and combinations thereof.

7. A method of facilitating the return of a lost electronic article, the method comprising:
a) offering to a point of service a plurality of adhesive tags, each of the tags having thereon convenient contact information of a first central registry organization;
b) urging the point of service to offer to a user a plurality of the tags, the plurality of tags having thereon a first identical anonymous user identification number to apply to at least one electronic article;
c) instantly registering with a first central registry organization the first anonymous user identification number and associated contact information of the user;
d) when a finder of the electronic article uses the convenient contact information to contact the first central registry organization, contacting the user from the first central registry organization to inform the buyer of the finding of the electronic article.

8. The method of claim 7, wherein the step c) of instantly registering with a first central registry organization the first anonymous user identification number and contact information of the user further comprises:
c1) dialing on a telephone a pre-provided telephone number to the first central registry organization; and
c2) providing to the first central registry organization the first anonymous user identification number and associated contact information of the user.

9. The method of claim 8, wherein the step c2) of providing to the first central registry organization the first anonymous user identification number and contact information of the user further comprises one member selected from the group consisting of: pushing buttons on the telephone to generate DTMF codes, speaking to a first central registry organization worker, and combinations thereof.

10. The method of claim 7, wherein the step c) of instantly registering with a first central registry organization the first anonymous user identification number and contact information of the user further comprises:
c3) accessing on a computer terminal a software device provided by the first central registry organization; and
c4) inputting on the computer terminal the first anonymous user identification number and contact information of the user.

11. The method of claim 7, wherein the point of service comprises one member selected from the group consisting of: rental agencies, hotels, airlines, airports, bus stations, restaurants, institutional lost and found collections, police departments, security departments, large companies, malls, office buildings, bus lines, train lines, subway systems, travel agencies, resorts, trade shows, conferences, convention centers, health clubs, college campuses, college dormitories, college buildings, reservation centers, and combinations thereof.

12. The method of claim 7, wherein the point of service comprises retailers.

13. A device for providing easy return to a user of an electronic item if lost, the device consisting of:
a) a plurality of tags applied to such electronic item;
b) said tags having thereon convenient contact information of a first central registry organization;
c) said tags having thereon the same anonymous user identification;
d) said tags provided to such user by a second participating organization; wherein
e) said anonymous user identification is provided to said first central registry organization along with contact information for such user, at the time when such user is provided with said tags by said second participating organization.
